(19) United States
(12) Patent Application Publication
(10) Pub. No.: US 2025/0272168 A1
(43) Pub. Date: Aug. 28, 2025

(54) UNIQUE IDENTIFIER GENERATION FOR GLOBALLY-UNIQUE INCREMENTING IDENTIFIERS USEFUL FOR ORDERING EVENTS

(71) Applicant: Goldman Sachs & Co. LLC, New York, NY (US)

(72) Inventor: Matti J. Oikarinen, Los Altos, CA (US)

(21) Appl. No.: 19/061,614

(22) Filed: Feb. 24, 2025

Related U.S. Application Data
(60) Provisional application No. 63/558,389, filed on Feb. 27, 2024.

(51) Int. Cl. G06F 9/54

(52) U.S. Cl. CPC G06F 9/542

(57) ABSTRACT

A method includes receiving, using at least one processing device of at least one electronic device, a request to generate a globally-unique identifier for an event. The method also includes identifying, using the at least one processing device, upper and lower time bounds of an error range that encompasses the event. The method further includes identifying, using the at least one processing device, a time associated with the event as the upper bound of the error range. In addition, the method includes generating, using the at least one processing device, the globally-unique identifier based on the identified time associated with the event.

### CROSS-REFERENCE TO RELATED APPLICATION AND PRIORITY CLAIM

This application claims priority under 35 U.S.C. § 119 (e) to U.S. Provisional Patent Application No. 63/558,389 filed on Feb. 27, 2024. This provisional application is hereby incorporated by reference in its entirety.

### TECHNICAL FIELD

This disclosure is generally directed to computing systems and other electronic systems. More specifically, this disclosure is directed to unique identifier generation for globally-unique incrementing identifiers useful for ordering events.

### BACKGROUND

Numerous computing systems and other systems use numerical identifiers or other identifiers in order to identify events that occur in those systems or that are otherwise identified by those systems. Unique identifiers are often useful in helping to uniquely identify events so that the events can be stored and retrieved or used in any other suitable manner. As a particular example, unique identifiers can be used to identify different sequences of events involving physical or other assets, such as a sequence of transfers involving a stock or other financial instrument.

### SUMMARY

This disclosure relates to unique identifier generation for globally-unique incrementing identifiers useful for ordering events.

In a first embodiment, a method includes receiving, using at least one processing device of at least one electronic device, a request to generate a globally-unique identifier for an event. The method also includes identifying, using the at least one processing device, upper and lower time bounds of an error range that encompasses the event. The method further includes identifying, using the at least one processing device, a time associated with the event as the upper bound of the error range. In addition, the method includes generating, using the at least one processing device, the globally-unique identifier based on the identified time associated with the event.

In a second embodiment, a system includes at least one processing device configured to receive a request to generate a globally-unique identifier for an event, identify upper and lower time bounds of an error range that encompasses the event, identify a time associated with the event as the upper bound of the error range, and generate the globally-unique identifier based on the identified time associated with the event.

In a third embodiment, a non-transitory computer readable medium contains instructions that when executed cause at least one processor to receive a request to generate a globally-unique identifier for an event, identify upper and lower time bounds of an error range that encompasses the event, identify a time associated with the event as the upper bound of the error range, and generate the globally-unique identifier based on the identified time associated with the event.

Any single one or any combination of the following features may be used with the first, second, or third embodiment.

A difference between the upper and lower bounds may be identified, and transmission of the identified time or the globally-unique identifier associated with the event may be delayed for an amount of time equal to the difference.

Requests to generate globally-unique identifiers for events may be repeatedly received, upper and lower time bounds may be identified, times associated with the events may be identified, and the globally-unique identifiers may be generated. By identifying the time associated with each event as the upper bound of the error range for that event and delaying the transmission of the identified time or the globally-unique identifier associated with each event for the amount of time equal to the difference for that event, it may be guaranteed that the globally-unique identifiers represent incrementing or increasing identifiers.

Requests to generate globally-unique identifiers for events may be repeatedly received, upper and lower time bounds may be identified, times associated with the events may be identified, and the globally-unique identifiers may be generated using multiple services executing in at least one of: different partitions and different regions. Each globally-unique identifier may have a format that includes (i) at least a portion of the identified time associated with the corresponding event and (ii) a partition uniqueness value used to avoid collisions within each partition. The partition uniqueness value may be based on a counter that resets any time one of the identified times associated with one of the events changes relative to the identified time associated with another of the events.

The globally-unique identifier may have a format that includes at least a portion of the identified time associated with the event. The format may include a truncated version of the identified time associated with the event. Transmission of the identified time or the globally-unique identifier associated with the event may be delayed for an amount of time equal to an accuracy of the truncated version of the identified time.

The format may include at least one of: a region identifier identifying a region associated with the event; a partition identifier identifying a partition associated with the event; and a partition uniqueness value used to avoid collisions within each partition.

The identified time associated with the event may be expressed using UNIX epoch time.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIGS. 1 and 2 illustrate example systems supporting unique identifier generation for globally-unique incrementing identifiers useful for ordering events in accordance with this disclosure;

FIG. 3 illustrates an example device supporting unique identifier generation for globally-unique incrementing identifiers useful for ordering events in accordance with this disclosure;

FIGS. 4 through 6 illustrate an example unique identifier generation for globally-unique incrementing identifiers useful for ordering events in accordance with this disclosure;

FIG. 7 illustrates an example format for globally-unique incrementing identifiers useful for ordering events in accordance with this disclosure; and

FIG. 8 illustrates an example method for unique identifier generation for globally-unique incrementing identifiers useful for ordering events in accordance with this disclosure.

### DETAILED DESCRIPTION

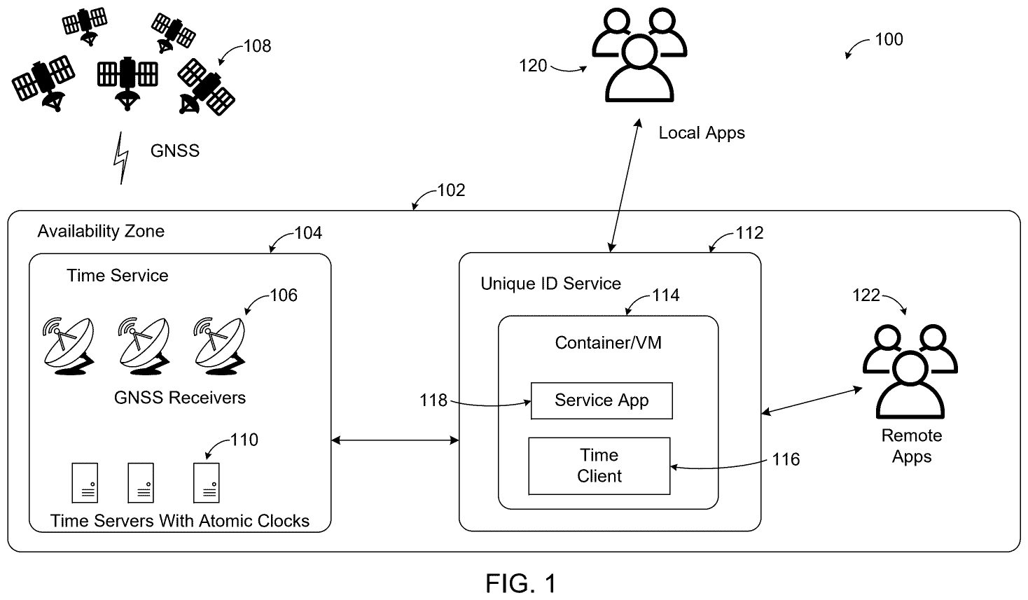

FIGS. 1 through 8, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

As noted above, numerous computing systems and other systems use numerical identifiers or other identifiers in order to identify events that occur in those systems or that are otherwise identified by those systems. Unique identifiers are often useful in helping to uniquely identify events so that the events can be stored and retrieved or used in any other suitable manner. As a particular example, unique identifiers can be used to identify different sequences of events involving physical or other assets, such as a sequence of transfers involving a stock or other financial instrument.

Unfortunately, the generation of unique identifiers is often performed separately by individual systems or by individual partitions within one or more systems. As a result, it is often difficult if not impossible to compare events across different partitions or across different systems without requiring the use of additional data (in addition to the unique identifiers themselves). Also, ordering of events can be difficult if not impossible across different partitions or across different systems. Operationally, many systems currently depend on database replication and selected leader nodes to issue unique identifiers. However, this 20 approach can reduce system availability and can cause duplicate identifiers to be issued if any operational or other errors occur (such as during server failovers).

This disclosure provides various techniques supporting unique identifier generation for globally-unique incrementing identifiers, which can be useful (among other things) for ordering events. As described in more detail below, a unique identifier service can be used to provide globally-unique incrementing identifiers. The unique identifier service can be implemented in various ways, such as on premises (like by using a local server or other computing device) or remote (like by using a remote server or other computing device or a cloud computing environment). The unique identifier service can utilize a time service with known clock error bounds to create globally-unique and incrementing identifiers, which can guarantee causal ordering. In some embodiments, the unique identifier service can be designed to be highly available and provide sub-millisecond response times. Also, in some embodiments, the globally-unique incrementing identifiers may be expressed as 64-bit or other numbers formatted using UNIX epoch time (such as when expressed in nanoseconds), which can be both compact and human-readable. Further, in some embodiments, the globally-unique incrementing identifiers may be usable as database primary keys and may be exposed in user-facing use cases (such as analytics). In addition, in some embodiments, the unique identifier service may be accessible via an application programming interface (API), such as one that supports commonly-used programming languages.

In this way, the globally-unique incrementing identifiers can be used across multiple system partitions or systems, such as for ordering events in the system partitions or systems. The use of similar but globally-unique incrementing identifiers can also allow for easier resolution of conflicts across complex partitions or systems and can enable events to be ordered globally. Moreover, the availability of accurate time services with known error bounds allows modernization in the way identifiers are generated, enables new system-wide use cases across diverse applications, and improves the behavior of existing systems. As an example use case, the globally-unique incrementing identifiers can enable new capabilities when comparing the order of events across different partitions or systems. As a particular example of a use case, the globally-unique incrementing identifiers can be used to prove that a first event (such as a data event) had no causal relationship to a second event (such as a stock trade or other transaction) since the first event occurred after the second event, even when the events occur in different system partitions or systems (including those in completely different regions of the world). In addition, traditional mechanisms like timestamps have large error bounds, which makes it impossible to identify the real order of events that occur close to each other, and system delays (such as garbage collection pauses) can make these approaches unreliable. The techniques described here provide the ability to compare events, which allows analytics and other data processing operations to occur (including those that involve ordering events) in a consistent fashion. As a particular example, this may allow risk management systems or other systems to obtain event data across a number of possible partitions or systems and to be able to accurately order the events from those partitions or systems, which may be useful for investigation, debugging, and development purposes.

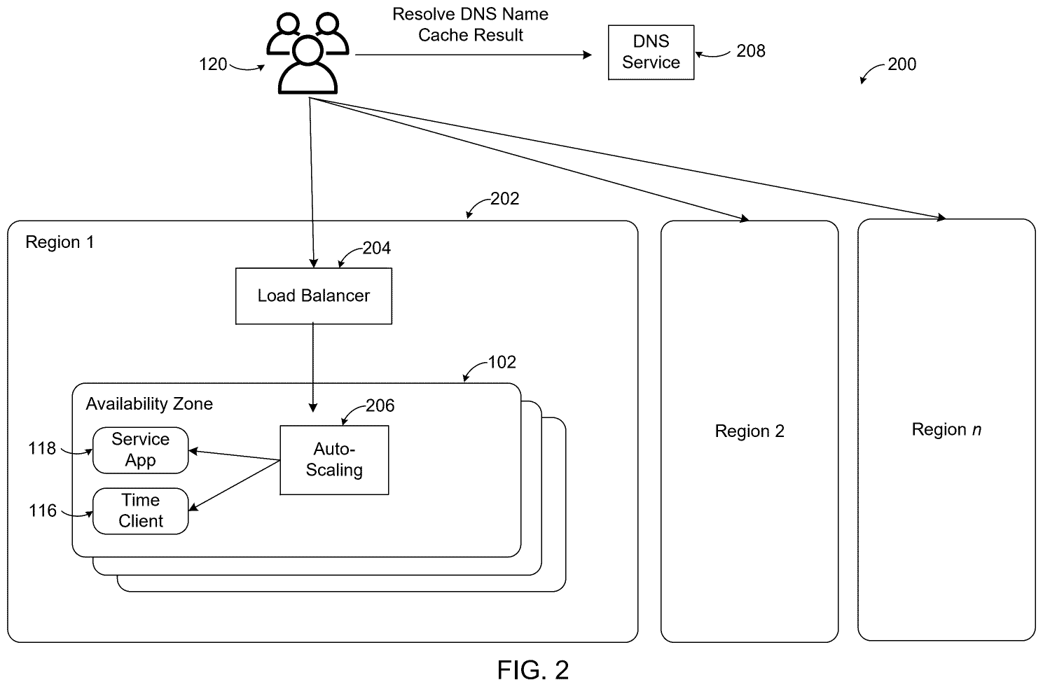

FIGS. 1 and 2 illustrate example systems 100, 200 supporting unique identifier generation for globally-unique incrementing identifiers useful for ordering events in accordance with this disclosure. As shown in FIG. 1, the system 100 is implemented within or is otherwise associated with an availability zone 102, which represents a partition, system, or other logical zone in which unique identifier generation for globally-unique incrementing identifiers can be used. In this example, the availability zone 102 includes a time service 104, which represents a service offered in or to the availability zone 102 that provides very accurate timekeeping for the availability zone 102. In this particular example, the time service 104 may include one or more Global Positioning System (GPS) or other Global Navigation Satellite System (GNSS) receivers 106 configured to receive signals from various GPS or other GNSS satellites 108. The time service 104 may also or alternatively include one or more time servers 110, each of which may include an atomic clock. The time service 104 may use any suitable technique(s) to identify time to within a specified level of accuracy. In some cases, the time service 104 may represent the GOOGLE TRUETIME service or the AMAZON WEB SERVICES (AWS) TIMESYNC service.

A unique identifier (ID) service 112 is also provided within the availability zone 102. The unique ID service 112 is configured to generate globally-unique identifiers as described in more detail below. Among other things, the unique ID service 112 can interact with the time service 104 in order to identify a measure of time as identified by the time service 104, and the unique ID service 112 can use that measure of time when generating the globally-unique identifiers. The unique ID service 112 can be implemented in any suitable manner within the availability zone 102. In this example, the unique ID service 112 may include logic executed within a container or virtual machine (VM) 114, which allows the unique ID service 112 to be easily executed by multiple or different computing devices within the availability zone 102 over time. The unique ID service 112 could also be accessed in any suitable manner, such as by using an API (like an HTML-, MIME-, or JSON-based API).

In this example, the unique ID service 112 includes a time client 116 and a service app 118. The time client 116 generally operates to interact with the time service 104 in order to obtain a relatively accurate measure of time from the time service 104. The time client 116 may be implemented in any suitable manner, such as by using a network time protocol (NTP) client or a precision time protocol (PTP) client. In some embodiments, the NTP client could support a time accuracy of less than about one millisecond, and the PTP client could support a time accuracy of less than about ten microseconds (although these values are examples only). The service app 118 generally operates to implement the unique identifier generation logic of the unique ID service 112. Example operations of the unique ID service 112 in general and the service app 118 specifically are provided below.

The unique ID service 112 can provide globally-unique identifiers to any suitable destinations. In this example, the unique ID service 112 can provide globally-unique identifiers to one or more local applications 120 and/or one or more remote applications 122. Each local application 120 may represent an application executed on premises of a user, which in some cases may represent a corporation or other organization. Each remote application 122 may represent an application executed remotely from a user, such as at a remote server or in a cloud computing environment.

As shown in FIG. 2, the availability zone 102 can be used as a basis for building a larger and more complex system 200. In this example, the system 200 includes one or more regions 202, each of which may be associated with a different geographical region or other physical or logical area. Each region 202 can include one or more availability zones 102. When different regions 202 are present, the different regions 202 may include the same number of availability zones 102 or different numbers of availability zones 102. Each region 202 can include at least one load balancer 204, which can be used to provide ID generation requests to different availability zones 102 based on the loads placed on the availability zones 102. Each availability zone 102 may also optionally include an auto-scaling function 206, which can be used to support a variable number of instances of the unique ID service 112 executing within the availability zone 102.

At least one domain name server (DNS) service 208 can be used to resolve DNS requests provided by the applications 120, 122. For example, a local resolver may be used to resolve DNS names provided by local applications 120, and the local resolver may query the DNS service 208. For the remote applications 122, the remote applications 122 may query the DNS service 208 directly. As can be seen here, the unique ID service 112 can be easily deployed across multiple regions 202 and availability zones 102.

In some embodiments, the unique ID service 112 may be used within the system 200 as follows.
Step 1: DNS Query—Each application 120, 122 can provide a DNS request that is resolved by a DNS service 208, which provides one or more Internet Protocol (IP) addresses or other network addresses to each application 120, 122. Note that the DNS service 208 can represent a service that typically has a 100% service-level agreement (SLA) availability or otherwise has a very high availability. Also note that DNS clients used by the applications 120, 122 may often cache responses from the DNS service 208, which enables the applications 120, 122 to reduce the number of DNS requests sent to the DNS service 208.
Step 2: Connection—Each application 120, 122 can open a Transmission Control Protocol (TCP) connection or other connection to one of the resolved IP addresses. Each IP address may be assigned to a load balancing service supported by the load balancers 204. If one connection attempt fails, each application 120, 122 may attempt a connection using another IP address. Note that there may be multiple routes from each application 120, 122 to instances of the unique ID service 112. In some cases, for example, four or more paths from each application 120, 122 to instances of the unique ID service 112 may be available. Also note that multiple direct connect links may be supported here. The use of multiple paths can again help to provide a 100% or other very high availability of the unique ID service 112. The load balancers 204 can be used here to support the multiple paths, and the load balancers 204 in some cases can represent regional services with a very high availability. However, note that the use of load balancers 204 is optional and that other approaches may be used to distribute ID generation requests to instances of the unique ID service 112.
Step 3: Security—After a TCP connection or other connection is established, each application 120, 122 may perform a Transport Layer Security (TLS) handshake or other handshake with a load balancer 204. Each load balancer 204 can also support certificate management. In some embodiments, certificates can be AWS-managed with full automation on rotation.
Step 4: Unique ID Generation—Each application 120, 122 can provide an ID generation request for a globally-unique identifier, such as by using an HTTP GET command or other suitable command. The load balancers 204 forward the requests to instances of the unique ID service 112, which can provide the globally-unique identifiers to the applications 120, 122. In some cases, each application 120, 122 can keep its connection to a load balancer 204 alive so as to avoid the need to perform multiple TLS or other handshakes.

As described above, the unique ID service 112 can be deployed across multiple regions 202 and availability zones 102. In some embodiments, the data plane of the system 200 may not have any cross-availability zone dependencies, except via the DNS and load balancing services (which can be global/regional services). The control plane of the system 200 may support cross-availability zone functionality for ensuring the uniqueness of the identifiers that are generated. This can be achieved in any suitable manner, such as by using partitioning in least significant bits of the unique identifiers that are generated.

Although FIGS. 1 and 2 illustrate examples of systems 100, 200 supporting unique identifier generation for globally-unique incrementing identifiers useful for ordering events, various changes may be made to FIGS. 1 and 2. For example, each system 100, 200 may include any suitable number of each component in any suitable arrangement. Also, the components of each system 100, 200 may be located in any suitable locations and might be distributed over a large area. In addition, while FIGS. 1 and 2 illustrate example operational environments in which unique identifier generation may be used, this functionality may be used in any other suitable system.

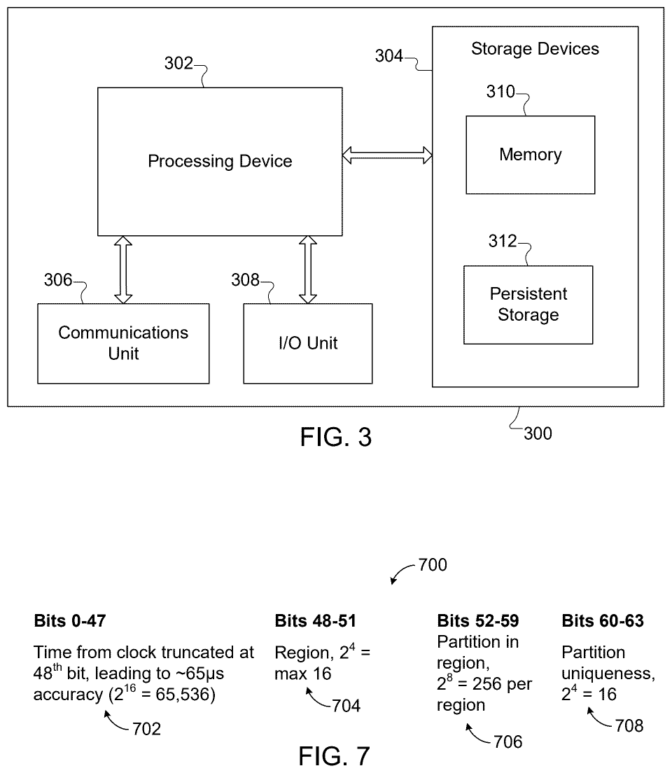

FIG. 3 illustrates an example device 300 supporting unique identifier generation for globally-unique incrementing identifiers useful for ordering events in accordance with this disclosure. For example, the device 300 may be used to execute or otherwise provide the unique ID service 112. However, the unique ID service 112 may be implemented in any other suitable manner.

As shown in FIG. 3, the device 300 denotes a computing device or system that includes at least one processing device 302, at least one storage device 304, at least one communications unit 306, and at least one input/output (I/O) unit 308. The processing device 302 may execute instructions that can be loaded into a memory 310. The processing device 302 includes any suitable number(s) and type(s) of processors or other processing devices in any suitable arrangement. Example types of processing devices 302 include one or more microprocessors, microcontrollers, digital signal processors (DSPs), application specific integrated circuits (ASICs), field programmable gate arrays (FPGAs), or discrete circuitry.

The memory 310 and a persistent storage 312 are examples of storage devices 304, which represent any structure(s) capable of storing and facilitating retrieval of information (such as data, program code, and/or other suitable information on a temporary or permanent basis). The memory 310 may represent a random access memory or any other suitable volatile or non-volatile storage device(s). The persistent storage 312 may contain one or more components or devices supporting longer-term storage of data, such as a read only memory, hard drive, Flash memory, or optical disc.

The communications unit 306 supports communications with other systems or devices. For example, the communications unit 306 can include a network interface card or a wireless transceiver facilitating communications over a wired or wireless network. The communications unit 306 may support communications through any suitable physical or wireless communication link(s).

The I/O unit 308 allows for input and output of data. For example, the I/O unit 308 may provide a connection for user input through a keyboard, mouse, keypad, touchscreen, or other suitable input device. The I/O unit 308 may also send output to a display, printer, or other suitable output device. Note, however, that the I/O unit 308 may be omitted if the device 300 does not require local I/O, such as when the device 300 represents a server or other device that can be accessed remotely.

In some embodiments, the instructions executed by the processing device 302 include instructions that implement or support the use of the unique ID service 112. Thus, for example, the instructions executed by the processing device 302 may cause the device 300 to obtain a time via the time client 116 and to use the time to generate a unique identifier (by implementing the service app 118).

Although FIG. 3 illustrates one example of a device 300 supporting unique identifier generation for globally-unique incrementing identifiers useful for ordering events, various changes may be made to FIG. 3. For example, computing and communication devices and systems come in a wide variety of configurations, and FIG. 3 does not limit this disclosure to any particular computing or communication device or system.

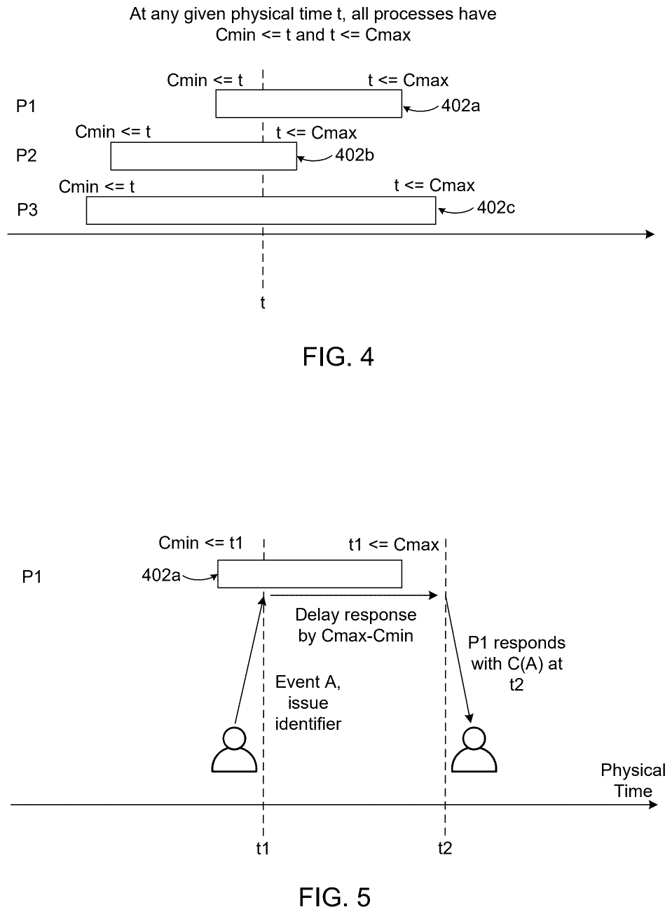

FIGS. 4 through 6 illustrate an example unique identifier generation for globally-unique incrementing identifiers useful for ordering events in accordance with this disclosure. For example, the techniques shown in FIGS. 4 through 6 may be used by the service app 118 of each unique ID service 112. In the discussion of FIGS. 4 through 6 below, the following notations are used. A “happened before” relationship is denoted using “→”. Thus, when event A occurs before event B, this can be expressed as “A→B”. A clock condition (meaning a time) for an event is denoted as “C(·)”, such as “C(A)” for event A and “C(B)” for event B. For any events A and B, if A→B, then C(a)<C(b). In other words, if event A occurs before event B, the clock condition for event A needs to be smaller than the clock condition for event B.

As shown in FIG. 4, multiple processes P1, P2, and P3 represent different instances of the unique ID service 112. Each process P1, P2, and P3 can generate unique identifiers based on time. However, each process P1, P2, and P3 may have some error bounds when determining what the current physical time actually is. That is, each process P1, P2, and P3 typically has error bounds defined by a minimum error Cmin and a maximum error Cmax. Thus, for any given time t, each process P1, P2, and P3 may (at best) be able to determine that the given time t falls within a range of times, which is referred to as a clock boundary 402a-402c. As a result, at any given time t, each process P1, P2, and P3 may only be able to determine that the time t is between its error bounds Cmin and Cmax, where Cmin<=t and t<=Cmax. These processes P1, P2, and P3 may lack coordination, so their error bounds can often be different, which means that different processes can have different values for Cmin and Cmax. However, because the clocks used by the processes P1, P2, and P3 are coordinated, the clock boundaries 402a-402c defined by their error bounds overlap one another (even if their clock boundaries 402a-402c are different).

Note that the error bounds defined by the Cmin and Cmax values for each process P1, P2, and P3 can be identified in any suitable manner. For example, the error bounds for any given instance of the unique ID services 112 can be based on the time service 104 used by the unique ID services 112. For example, the GOOGLE TRUETIME service and the AWS TIMESYNC service have known clock error bounds. Similar error bounds can be derived if one or more time servers 110 are used to provide the time service 104.

To ensure an incrementing time for use during identifier generation, the following process can be used. As shown in FIG. 5, the process P1 is being used to generate a time C(A) for event A. It is assumed here that event A occurs at time t1. However, as noted above, the process P1 may not know precisely when time t1 occurs, only that time t1 occurs within a range defined by the Cmin and Cmax values of the process P1. To help compensate for this, the upper bound of the clock boundary 402a for the process P1 can be assigned as the time for C(A), meaning C(A)=Cmax of P1, even though this time is larger than the actual time t1 of event A. The process P1 can also introduce a delay based on the difference between its Cmax and Cmin values (meaning Cmax−Cmin) before returning the clock condition C(A) to a requesting application 120, 122. This approach therefore delays the response for the maximum error bound to ensure that the physical time t2>=Cmax at the time that the process P1 returns the response. Note that this delay can also include the maximum local clock skew to satisfy the condition t2>=Cmax. In other words, this approach uses the upper bound of the clock boundary 402a as the time used for creating an event identifier, and the process delays sending of the clock condition for the length of the clock boundary 402a.

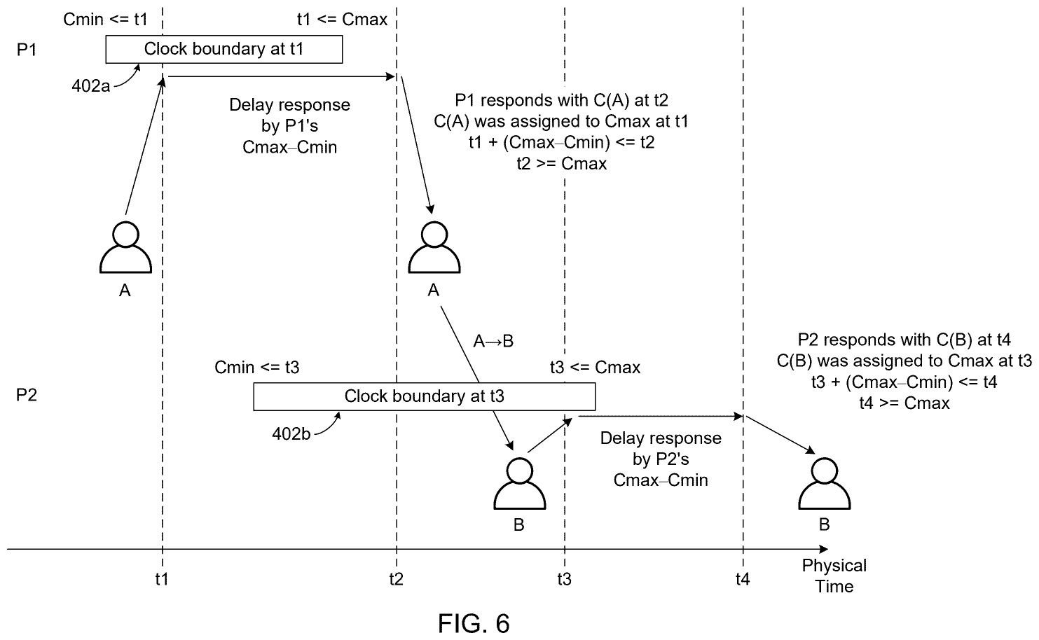

FIG. 6 illustrates how this approach can be replicated across multiple unique ID services 112 in order to ensure that globally-unique incrementing identifiers are generated for events occurring in a sequence. This means that when A→B, the described approach ensures that C(A)<C (B). As shown in FIG. 6, the process P1 identifies the upper bound of its clock boundary 402a as the time of an event A, and the process P1 delays sending the response for P1's Cmax−Cmin, which occurs at time t2. Subsequently, the process P2 identifies the upper bound of its clock boundary 402b as the time of an event B, and the process P2 delays sending the response for P2's Cmax−Cmin, which occurs at time t4. Note that the process P2 cannot send its response at time t3 since its clock boundary 402b passes time t3, so the time assigned to event B is past time t3. Also note that these figures are not drawn to scale since t4 here is assumed to be delayed by P2's Cmax−Cmin, but the separation of t3 and t4 here is shorter in FIG. 6 than the illustrated length of P2's clock boundary 402b.

This approach guarantees that the clock condition C(A) assigned to event A is smaller than the clock condition C (B) assigned to event B, which is needed given the assumption that A→B. Note here that using the upper bound of a clock boundary 402a-402c as the assigned time of an event, plus delaying the response by the difference between the Cmax and Cmin values of the clock boundary 402a-402c, ensures that the actual physical time is higher than the assigned clock condition when the clock condition is reported. This guarantees generation of increasing or incrementing unique identifiers.

Although FIGS. 4 through 6 illustrate one example of unique identifier generation for globally-unique incrementing identifiers useful for ordering events, various changes may be made to FIGS. 4 through 6. For example, the sizes of the various clock boundaries 402a-402c can vary based on the implementation.

FIG. 7 illustrates an example format 700 for globally-unique incrementing identifiers useful for ordering events in accordance with this disclosure. This format 700 may, for example, be used in conjunction with the clock conditions generated as explained above with respect to FIGS. 4 through 6 to generate globally-unique incrementing identifiers.

As shown in FIG. 7, the format 700 includes at least a portion of a clock condition 702, which may represent a time as identified by a unique ID service 112 based on the upper bound of a clock boundary 402a-402c. Among other things, this may allow applications 120, 122 or users to treat the globally-unique incrementing identifiers as timestamps. Here, the format 700 includes a truncated clock condition 702, which in this specific example includes the top 48 bits of a 64-bit clock condition. By dropping the last sixteen bits of the 64-bit clock condition, this gives an accuracy of about 65 microseconds. Note, however, that the complete 64-bit clock condition may be used or that other truncated versions of the 64-bit clock condition may be used. Also note that the clock condition may have a length of other than 64-bits. In addition, note that when the clock condition is truncated, the delay in sending a response that contains a globally-unique identifier can be delayed to account for the clock condition's accuracy. Thus, for example, if the clock condition is truncated so as to have an accuracy of 100 microseconds, a response containing a globally-unique identifier based on the clock condition can be delayed by 100 microseconds to ensure that any subsequent identifier is higher (even though accuracy is limited to 100 microseconds).

The format 700 also includes a region identifier 704 and a partition identifier 706. In this example, the region identifier 704 is four bits (allowing for up to sixteen regions 202), and the partition identifier 706 is eight bits (allowing for up to 256 partitions or availability zones 102). However, these lengths can vary as needed or desired. Also, it is possible to merge the region and partition identifiers 704 and 706 into a single identifier, such as when doing do makes distributing capacity across partitions easier.

The format 700 further includes a partition uniqueness value 708, which may be reserved to avoid collisions within each partition. In some cases, for example, the partition uniqueness value 708 can be based on a counter that resets any time the clock condition 702 changes. In this example, this means that the partition uniqueness value 708 may be reset every 65 microseconds.

Although FIG. 7 illustrates one example of a format 700 for globally-unique incrementing identifiers useful for ordering events, various changes may be made to FIG. 7. For example, the format 700 may include any other or additional fields, and each field may include any suitable number of bits. Also, the arrangement of the fields in the format 700 can vary as needed or desired.

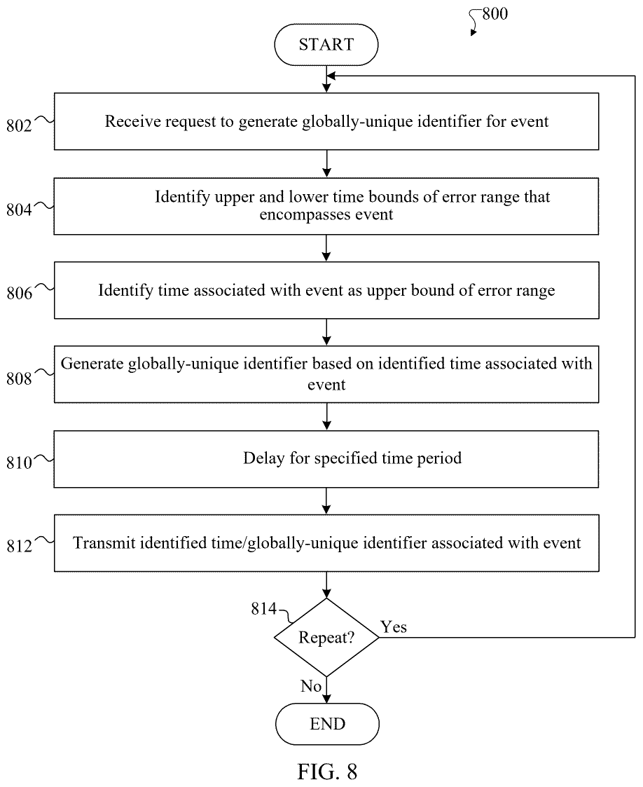

FIG. 8 illustrates an example method 800 for unique identifier generation for globally-unique incrementing identifiers useful for ordering events in accordance with this disclosure. For case of explanation, the method 800 is described as being performed using a unique ID service 112 in the system 100 or 200 shown in FIG. 1 or 2, where the unique ID service 112 may be performed using an instance of the device 300 shown in FIG. 3 and may generate unique identifiers using the techniques shown in FIGS. 4 through 6. However, the method 800 may be performed using any other suitable device or system and may be implemented in any other suitable manner.

As shown in FIG. 8, a request to generate a globally-unique identifier for an event is received at step 802. This may include, for example, the at least one processing device 302 of the device 300 that provides the unique ID service 112 receiving the request from a local application 120 or a remote application 122. Upper and lower time bounds of an error range that encompasses the event is identified at step 804. This may include, for example, the at least one processing device 302 of the device 300 identifying the error bounds that encompasses the event, where the error bounds are defined by a minimum error Cmin and a maximum error Cmax. The error bounds can define a clock boundary 402a-402c associated with the event. A time associated with the event is identified as the upper bound of the error range at step 806. This may include, for example, the at least one processing device 302 of the device 300 identifying the maximum or upper time associated with the clock boundary 402a-402c as being the time associated with the event. In some cases, the identified time associated with the event may be expressed using UNIX epoch time.

A globally-unique identifier is generated based on the identified time associated with the event at step 808. This may include, for example, the at least one processing device 302 of the device 300 generating a globally-unique identifier having a format that includes at least a portion of the identified time associated with the event. In some cases, the format may include a truncated version of the identified time associated with the event. The globally-unique identifier may include any other suitable contents. For instance, in some cases, the globally-unique identifier may include a region identifier identifying a region associated with the event, a partition identifier identifying a partition associated with the event, and a partition uniqueness value used to avoid collisions within each partition. As a particular example, the globally-unique identifier may include a partition uniqueness value used to avoid collisions within a partition, where the partition uniqueness value is based on a counter that resets any time an identified time associated with one event changes relative to an identified time associated with another event.

A delay for a specified time period occurs at step 810, after which the identified time or globally-unique identifier associated with the event is transmitted at step 812. This may include, for example, the at least one processing device 302 of the device 300 calculating a suitable delay and transmitting the identified time or globally-unique identifier associated with the event to the local application 120 or remote application 122 after the delay. In some cases, the delay may be calculated by identifying a difference between the upper and lower time bounds of the error range, in which case the transmission of the identified time or globally-unique identifier associated with the event can be delayed for an amount of time equal to the difference. In other cases, such as when the globally-unique identifier includes a truncated version of the identified time associated with the event, the delay may be calculated as an amount of time equal to an accuracy of the truncated version of the identified time, in which case the transmission of the identified time or globally-unique identifier associated with the event can be delayed for the same amount of time.

If the process is to be repeated at step 814, the method 800 can return to step 802 to receive another request. This allows the unique ID service 112 to repeatedly receive requests to generate globally-unique identifiers for events, identify upper and lower time bounds, identify times associated with the events, and generate the globally-unique identifiers. By identifying the time associated with each event as the upper bound of the error range for that event and delaying the transmission of the identified time or the globally-unique identifier associated with each event, this can guarantee that the globally-unique identifiers represent incrementing or increasing identifiers.

Although FIG. 8 illustrates one example of a method 800 for unique identifier generation for globally-unique incrementing identifiers useful for ordering events, various changes may be made to FIG. 8. For example, while shown as a series of steps, various steps in FIG. 8 may overlap, occur in parallel, occur in a different order, or occur any number of times (including zero times). Also, the method 800 here can be repeated for any number of requests being handled by the unique ID service 112. In addition, the method 800 here can be performed by any number of instances of the unique ID service 112, such as by different instances of the unique ID service 112 executing in different partitions or different regions.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving, using at least one processing device of at least one electronic device, a request to generate a globally-unique identifier for an event;
identifying, using the at least one processing device, upper and lower time bounds of an error range that encompasses the event;
identifying, using the at least one processing device, a time associated with the event as the upper bound of the error range; and
generating, using the at least one processing device, the globally-unique identifier based on the identified time associated with the event.

2. The method of claim 1, further comprising:
identifying a difference between the upper and lower bounds; and
delaying transmission of the identified time or the globally-unique identifier associated with the event for an amount of time equal to the difference.

3. The method of claim 2, further comprising:
repeatedly receiving requests to generate globally-unique identifiers for events, identifying upper and lower time bounds, identifying times associated with the events, and generating the globally-unique identifiers;
wherein identifying the time associated with each event as the upper bound of the error range for that event and delaying the transmission of the identified time or the globally-unique identifier associated with each event for the amount of time equal to the difference for that event guarantees that the globally-unique identifiers represent incrementing or increasing identifiers.

4. The method of claim 1, further comprising:
repeatedly receiving requests to generate globally-unique identifiers for events, identifying upper and lower time bounds, identifying times associated with the events, and generating the globally-unique identifiers using multiple services executing in at least one of: different partitions and different regions.

5. The method of claim 4, wherein:
each globally-unique identifier has a format that comprises (i) at least a portion of the identified time associated with the corresponding event and (ii) a partition uniqueness value used to avoid collisions within each partition; and
the partition uniqueness value is based on a counter that resets any time one of the identified times associated with one of the events changes relative to the identified time associated with another of the events.

6. The method of claim 1, wherein the globally-unique identifier has a format that comprises at least a portion of the identified time associated with the event.

7. The method of claim 6, wherein the format comprises a truncated version of the identified time associated with the event.

8. The method of claim 7, further comprising:
delaying transmission of the identified time or the globally-unique identifier associated with the event for an amount of time equal to an accuracy of the truncated version of the identified time.

9. The method of claim 6, wherein the format further comprises at least one of:
a region identifier identifying a region associated with the event;
a partition identifier identifying a partition associated with the event; and
a partition uniqueness value used to avoid collisions within each partition.

10. The method of claim 1, wherein the identified time associated with the event is expressed using UNIX epoch time.

11. A system comprising:
at least one processing device configured to:
receive a request to generate a globally-unique identifier for an event;
identify upper and lower time bounds of an error range that encompasses the event;
identify a time associated with the event as the upper bound of the error range; and
generate the globally-unique identifier based on the identified time associated with the event.

12. The system of claim 11, wherein the at least one processing device is further configured to:
identify a difference between the upper and lower bounds; and
delay transmission of the identified time or the globally-unique identifier associated with the event for an amount of time equal to the difference.

13. The system of claim 12, wherein:
the at least one processing device is configured to repeatedly receive requests to generate globally-unique identifiers for events, identify upper and lower time bounds, identify times associated with the events, and generate the globally-unique identifiers; and
the at least one processing device is configured, by identifying the time associated with each event as the upper bound of the error range for that event and delaying the transmission of the identified time or the globally-unique identifier associated with each event for the amount of time equal to the difference for that event, to guarantee that the globally-unique identifiers represent incrementing or increasing identifiers.

14. The system of claim 11, wherein the at least one processing device is further configured to repeatedly receive requests to generate globally-unique identifiers for events, identify upper and lower time bounds, identify times associated with the events, and generate the globally-unique identifiers using multiple services executing in at least one of: different partitions and different regions.

15. The system of claim 11, wherein the globally-unique identifier has a format that comprises at least a portion of the identified time associated with the event.

16. The system of claim 15, wherein:
the format comprises a truncated version of the identified time associated with the event; and
the at least one processing device is further configured to delay transmission of the identified time or the globally-unique identifier associated with the event for an amount of time equal to an accuracy of the truncated version of the identified time.

17. A non-transitory computer readable medium containing instructions that when executed cause at least one processor to:
receive a request to generate a globally-unique identifier for an event;
identify upper and lower time bounds of an error range that encompasses the event;
identify a time associated with the event as the upper bound of the error range; and
generate the globally-unique identifier based on the identified time associated with the event.

18. The non-transitory computer readable medium of claim 17, further containing instructions that when executed cause the at least one processor to:
identify a difference between the upper and lower bounds; and
delay transmission of the identified time or the globally-unique identifier associated with the event for an amount of time equal to the difference.

19. The non-transitory computer readable medium of claim 18, wherein:
the instructions when executed cause the at least one processor to repeatedly receive requests to generate globally-unique identifiers for events, identify upper and lower time bounds, identify times associated with the events, and generate the globally-unique identifiers; and
the instructions when executed cause the at least one processor, by identifying the time associated with each event as the upper bound of the error range for that event and delaying the transmission of the identified time or the globally-unique identifier associated with each event for the amount of time equal to the difference for that event, to guarantee that the globally-unique identifiers represent incrementing or increasing identifiers.

20. The non-transitory computer readable medium of claim 17, wherein:
the globally-unique identifier has a format that comprises at least a portion of the identified time associated with the event;
the format comprises a truncated version of the identified time associated with the event; and
the instructions when executed cause the at least one processor to delay transmission of the identified time or the globally-unique identifier associated with the event for an amount of time equal to an accuracy of the truncated version of the identified time.
